(19) United States
(12) Patent Application Publication
(10) Pub. No.: US 2025/0139732 A1
(43) Pub. Date: May 1, 2025

(54) METHOD FOR ALLOCATING MEMORY DURING HOMOMORPHIC CIPHERTEXT OPERATION AND APPARATUS THEREOF

(71) Applicant: CRYPTO LAB INC., Seoul (KR)

(72) Inventors: Sunchul Jung, Seoul (KR); Jake Choi, Seoul (KR); Jaejin Lee, Suwon-si (KR)

(21) Appl. No.: 18/925,743

(22) Filed: Oct. 24, 2024

(30) Foreign Application Priority Data
Oct. 25, 2023 (KR) 10-2023-0144220
Oct. 23, 2024 (KR) 10-2024-0145531

(51) Int. Cl. G06T 1/60; H04L 9/00

(52) U.S. Cl. CPC G06T 1/60; H04L 9/008

(57) ABSTRACT

Disclosed is an electronic apparatus. The apparatus includes a memory, and a processor configured to perform a homomorphic operation by performing at least one instruction, wherein the processor is configured to use a first allocation method for allocating a memory region in a stream order to allocate the memory region required for each instruction while performing the at least one instruction, and use a second allocation method for allocating the memory region by using a synchronization method if a predetermined situation occurs.

### TECHNICAL FIELD

The present disclosure relates to a method for allocating a memory during a homomorphic ciphertext operation and an apparatus thereof, and more particularly, to a method for allocating a memory to prevent a memory shortage problem during a homomorphic ciphertext operation and minimize a resulting operation delay, and an electronic apparatus thereof.

### BACKGROUND ART

In accordance with the development of communication technology and a growing spread of electronic apparatuses, efforts are continuously being made to maintain communication security between the electronic apparatuses. Accordingly, encryption/decryption technology is used in most communication environments.

If a message encrypted by the encryption technology is delivered to the other party, the other party may be required to perform decryption to use the message. In this case, the other party may waste resources and time in a process of decrypting encrypted data. In addition, the message may be easily leaked to a third party if the message temporarily decrypted by the other party for an operation is hacked by the third party.

A homomorphic encryption method is being studied to solve this problem. In case of using the homomorphic encryption method, it is possible to acquire the same result as an encrypted value acquired after performing the operation on a plaintext even if the operation is performed on a ciphertext itself without decrypting the encrypted information.

The homomorphic ciphertext may require high operation resources during an operation process despite its advantage of being able to perform the operation in an encrypted state.

Recently, a graphics-processing unit (GPU) has been used to solve a performance bottleneck that occurs during a fully homomorphic encryption (FHE) operation on the homomorphic ciphertext, especially during its reboot. However, a GPU memory is limited compared to typical host dynamic random access (DRAM) memory and is unable to be easily expanded.

In this regard, in case of using a graphics card having a small GPU memory capacity, an error may occur or the operation may not be performed due to a memory shortage in the operation process of the homomorphic ciphertext.

### Technical Solution

According to an embodiment of the present disclosure, provided is an electronic apparatus including: a memory; and a processor configured to perform a homomorphic operation by performing at least one instruction, wherein the processor is configured to use a first allocation method for allocating a memory region in a stream order to allocate the memory region required for each instruction while performing the at least one instruction, and use a second allocation method for allocating the memory region by using a synchronization method if a predetermined situation occurs.

The processor may be configured to use the second allocation method if usage of a graphics-processing unit (GPU) memory is a predetermined ratio or more and an operation object that requires a long operation time is in operation.

The operation object may use at least one of a bootstrapping operation or a fully homomorphic encryption (FHE) operation.

The processor may be configured to check whether the operation object that requires a long operation time is in operation based on a difference between the maximum and minimum values of a list within a predetermined time.

The memory may include a first memory using a dynamic random-access memory (DRAM) method and a second memory using a video random access memory (VRAM) method, and the processor may be configured to unify and manage the first memory and the second memory, and allocate an object related to the homomorphic operation to at least one of the first memory or the second memory.

The processor may be configured to allocate the object related to the homomorphic operation to the second memory if usage of a graphics-processing unit (GPU) memory is less than a predetermined ratio.

The processor may be configured to manage information on a list of blocks corresponding to the plurality of memory regions and indicating whether each block is in use, and check an active object in current use based on the list.

According to an embodiment of the present disclosure, provided is control method of an electronic apparatus, the method including: checking a predetermined situation if a memory allocation request is input as at least one instruction is performed;

using a first allocation method for allocating a memory region in a stream order to allocate the memory region required for each instruction while the at least one instruction is performed if no predetermined situation occurs; and using a second allocation method for allocating the memory region by using a synchronization method if the predetermined situation occurs.

In the checking, whether usage of a graphics-processing unit (GPU) memory is a predetermined ratio or more and an operation object that requires a long operation time is in operation may be checked.

The operation object may use at least one of a bootstrapping operation or a fully homomorphic encryption (FHE) operation.

In the checking, whether the operation object that requires a long operation time is in operation may be checked based on a difference between the maximum and minimum values of a list within a predetermined time.

The method, in which the electronic apparatus includes a first memory using a dynamic random-access memory (DRAM) method and a second memory using a video random access memory (VRAM) method, wherein in the using of the second allocation method, the first memory and the second memory may be unified and managed, and an object related to a homomorphic operation may be allocated to at least one of the first memory or the second memory.

In the using of the first allocation method, the object related to the homomorphic operation may be allocated to the second memory if usage of a graphics-processing unit (GPU) memory is less than a predetermined ratio.

In the checking, information on a list of blocks corresponding to the plurality of memory regions and indicating whether each block is in use may be managed, and an active object in current use may be checked based on the list.

According to an embodiment of the present disclosure, provided is a non-transitory computer-readable recording medium storing a program for executing a control method of an electronic apparatus, wherein the method includes checking a predetermined situation if a memory allocation request is input as at least one instruction is performed, using a first allocation method for allocating a memory region in a stream order to allocate the memory region required for each instruction while the at least one instruction is performed if no predetermined situation occurs, and using a second allocation method for allocating the memory region by using a synchronization method if the predetermined situation occurs.

### DESCRIPTION OF DRAWINGS

The above or other aspects, features, or benefits of embodiments in the present disclosure will be more apparent by the description provided below with reference to the accompanying drawings, in which:

FIG. 1 is a diagram showing a structure of a network system according to an embodiment of the present disclosure;

FIG. 2 is a block diagram showing a configuration of an electronic apparatus according to an embodiment of the present disclosure;

FIG. 3 is a diagram showing a memory configuration according to the present disclosure;

FIG. 4 is a diagram showing a method for allocating a memory according to an embodiment of the present disclosure;

FIG. 5 is a diagram showing an operation example in case of using an asynchronous allocation method;

FIG. 6 is a diagram showing an operation example in case of using a synchronous allocation method;

FIG. 7 is a diagram showing a memory allocation delay time based on the two allocation methods;

FIG. 8 is a diagram showing a ratio of the asynchronous allocation method;

FIG. 9 is a diagram showing a profiling allocation scheme according to an embodiment of the present disclosure;

FIG. 10 is a graph showing the number of occurrences based on a lifespan of each object;

FIG. 11 is a diagram showing a scatter plot of each graphics-processing unit (GPU) object;

FIG. 12 is a diagram showing the maximum memory usage of the GPU object;

FIG. 13 is a diagram showing a dynamic allocation method according to the present disclosure;

FIG. 14 is a diagram showing a difference in homomorphic processing speeds based on the maximum asynchronous allocation speed;

FIG. 15 is a diagram showing performance of various homomorphic operations;

FIG. 16 is a diagram showing performance of various homomorphic operations; and

FIG. 17 is a flowchart showing a homomorphic processing method according to an embodiment of the present disclosure.

### BEST MODE

Hereinafter, the present disclosure is described in detail with reference to the accompanying drawings. Encryption/decryption may be applied as necessary to a process of transmitting information (or data) that is performed in the present disclosure, and an expression describing the process of transmitting the information (or data) in the present disclosure and the claims should be interpreted as also including cases of encrypting/decrypting the information (or data) even if not separately mentioned. In the present disclosure, an expression such as “transmission (transfer) from A to B” or “reception from A to B” may include transmission (transfer) or reception while having another medium included in the middle, and may not necessarily express only the direct transmission (transfer) or reception from A to B.

In describing the present disclosure, a sequence of each operation should be understood as non-restrictive unless a preceding operation in the sequence of each operation needs to logically and temporally precede a subsequent operation. That is, except for the above exceptional case, the essence of the present disclosure is not affected even if a process described as the subsequent operation is performed before a process described as the preceding operation, and the scope of the present disclosure should also be defined regardless of the sequences of the operations. In addition, in the specification, “A or B” may be defined to indicate not only selectively indicating either one of A and B, but also including both A and B. In addition, a term “including” in the present disclosure may have a meaning encompassing further including other components in addition to components listed as being included.

The present disclosure only describes essential components necessary for describing the present disclosure, and does not mention components unrelated to the essence of the present disclosure. In addition, it should not be interpreted as an exclusive meaning that the present disclosure includes only the mentioned components, and should be interpreted as a non-exclusive meaning that the present disclosure may include other components as well.

In addition, the present disclosure, a “value” may be defined as a concept that includes a vector as well as a scalar value. In addition, in the present disclosure, an expression such as “calculate” or “compute” may be replaced with an expression of generating a result of the corresponding calculation or computation. In addition, unless otherwise specified, an operation on a ciphertext described below indicates a homomorphic operation. For example, addition of homomorphic ciphertexts indicates homomorphic addition for the two homomorphic ciphertexts.

Mathematical operations and calculations in each step of the present disclosure described below may be implemented as computer operations by a known coding method and/or coding designed to be suitable for the present disclosure to perform the corresponding operations or calculations.

Specific equations described below are exemplarily described among possible alternatives, and the scope of the present disclosure should not be construed as being limited to the equations mentioned in the present disclosure.

For convenience of description, the present disclosure defines the following notations:
a←D: Select an element a based on distribution D.

s1, s2∈R: Each of S1 and S2 is an element belonging to a set R.
mod (q): Perform modular operation using an element “q”.
└Ψ┐: Round an internal value.

Hereinafter, various embodiments of the present disclosure are described in detail with reference to the accompanying drawings.

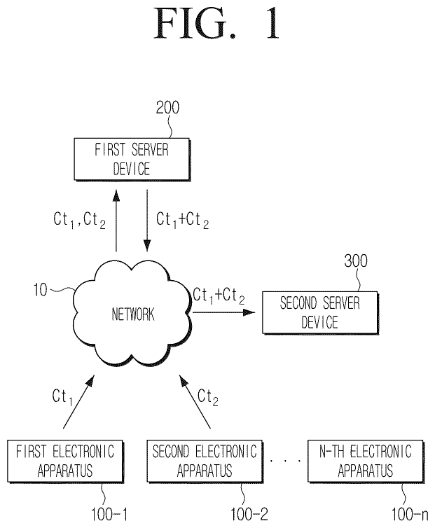

FIG. 1 is a diagram showing a structure of a network system according to an embodiment of the present disclosure.

Referring to FIG. 1, the network system may include a plurality of electronic apparatuses 100-1 to 100-n, a first server device 200, and a second server device 300, and the respective devices may be connected to each other through a network 10.

The network 10 may be implemented in any of various types of wired and wireless communication networks, broadcast communication networks, optical communication networks, cloud networks, and the like, and the respective apparatuses may be connected to each other in a way such as wireless-fidelity (WiFi), Bluetooth, or near field communication (NFC) without a separate medium.

FIG. 1 shows the plurality of electronic apparatuses 100-1 to 100-n. However, the plurality of electronic apparatuses may not be necessarily used, and one apparatus may be used. As an example, the electronic apparatuses 100-1 to 100-n may be implemented in various types of apparatuses such as smartphones, tablets, game players, personal computers (PCs), laptops, home servers, and kiosks, and may also be implemented in other types of home appliances each having an internet of things (IoT) functions.

A user may input various information through the electronic apparatuses 100-1 to 100-n used by the user. The input information may be stored in the electronic apparatuses 100-1 to 100-n themselves, or transmitted and stored in an external device for storage capacity, a security reason, or the like. In FIG. 1, the first server device 200 may serve to store this information, and the second server device 300 may serve to use some or all of the information stored in the first server device 200.

Each of the electronic apparatuses 100-1 to 100-n may homomorphically encrypt the input information and transmit a homomorphic ciphertext to the first server device 200.

Each of the electronic apparatuses 100-1 to 100-n may allow an error, that is, encryption noise produced in a process of performing the homomorphic encryption to be included in the ciphertext. In detail, the homomorphic ciphertext generated by each of the electronic apparatuses 100-1 to 100-n may be generated to restore a result value including a message and an error value if the homomorphic ciphertext is later decrypted using a secret key.

As an example, the homomorphic ciphertext generated by each of the electronic apparatuses 100-1 to 100-n may be generated to satisfy the following properties in case of being decrypted using the secret key.

$$Dec ( ct , sk ) = < ct , sk >= M + e ( mod q ) \qquad [ Equation 1 ]$$

Here, < and > indicate dot product calculation (or usual inner product), ct indicates the ciphertext, sk indicates the secret key, M indicates a plaintext message, e indicates an encryption error value, and mod q indicates a modulus of the ciphertext. q needs to be selected to be larger than a result value M multiplied by a scaling factor Δ to the message. If an absolute value of the error value e is sufficiently smaller than M, a decryption value M+e of the ciphertext may be a value that is capable of replacing an original message by the same precision in a significant figure operation. Among decrypted data, the error may be disposed on the least significant bit (LSB) side, and M may be disposed on the next least significant bit side.

If a size of the message is too small or too large, the size may be adjusted using the scaling factor. In case of using the scaling factor, not only the message in an integer form but also the message in a real number form may be encrypted, thus greatly increasing its usability. In addition, the size of the message may be adjusted using the scaling factor to thus also adjust a size of an effective region, that is, a region where the messages exist in the ciphertext after the operation is performed on the message.

In some embodiments, the modulus q of the ciphertext may be set and used in various forms. As an example, the modulus of the ciphertext may be set in a form of an exponential power q=Δ^{L} of the scaling factor Δ. If Δ is 2, the modulus may be set to a value such as q=2¹⁰. Meanwhile, one scaling factor or different scaling factors may be used for the homomorphic ciphertext. For example, the scaling factor having a high value and capable of maintaining corresponding precision may be used in an environment requiring high precision, and a lower scaling factor than the corresponding scaling factor may be used in an environment requiring relatively low precision.

The electronic apparatuses 100-1 to 100-n may use a host program (using a central processing unit (CPU) and a main memory) and an acceleration kernel (written in a graphics-processing unit (GPU) language) that perform homomorphic encryption operations.

In this way, the electronic apparatus needs to delegate as much computationally intensive tasks as possible to the GPU to improve performance of the homomorphic operation.

Here, an amount of information required to execute the GPU-accelerated task (by the acceleration kernel) may be so large that the information is unable to be accommodated by a video random access memory (VRAM) mounted on a low-specification GPU. While a conventional approach may stop the execution due to a memory shortage (out of memory, OOM) error, the present disclosure suggests a solution that allows a homomorphic operation application to be executed even on the low-specification GPU.

In detail, each of the electronic apparatuses 100-1 to 100-n may generate the homomorphic ciphertext by using a method for allocating a memory according to the present disclosure in the process of generating the homomorphic ciphertext described above. In detail, each of the electronic apparatuses 100-1 to 100-n may allocate the memory by using a hybrid allocation method described below in the present disclosure. Meanwhile, in implementation, the hybrid allocation method may be applied not only to the generation process for the homomorphic ciphertext, but also to processes for its operation, decryption, or the like.

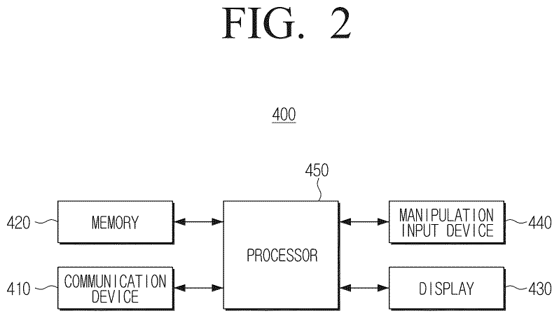

Here, the hybrid allocation method indicates a method of selectively using a first allocation method and a second allocation method based on a case. First, the first allocation method indicates a method of asynchronously allocating a memory region in the GPU memory in a stream order. In addition, the second allocation method indicates a method of using a unified memory by unifying the GPU memory and the CPU memory and using the two memories together in a particular case. Details of this allocation method are described below with reference to FIG. 2.

The first server device 200 may store the received encrypted homomorphic ciphertext in a ciphertext state without decrypting the same.

The second server device 300 may request a specific processing result of the homomorphic ciphertext from the first server device 200. The first server device 200 may perform a specific operation based on the request of the second server device 300 and then transmit its result to the second server device 300.

As an example, ciphertexts ct1 and ct2 transmitted by the two electronic apparatuses 100-1 and 100-2 may be stored in the first server device 200. In this case, the second server device 300 may request the first server device 200 for the sum of information provided from the two electronic apparatuses 100-1 and 100-2. The first server device 200 may perform an operation of summing the two ciphertexts based on the request, and then transmit a result value ct1+ct2 to the second server device 300.

Due to a property of the homomorphic ciphertext, the first server device 200 may perform the operation without the decryption, and the result value may also be in a form of the ciphertext. In the present disclosure, the result value acquired by the operation is referred to as an operation result ciphertext.

The first server device 200 may transmit the operation result ciphertext to the second server device 300. The second server device 300 may decrypt the received operation result ciphertext to thus acquire the operation result value of data included in each homomorphic ciphertext.

The first server device 200 may perform the operation multiple times based on a user request. In this case, the operation result ciphertext acquired for each operation may have a different approximate message weight. The first server device 200 may perform a bootstrapping operation if the approximate message weight is more than a threshold value. Accordingly, the first server device 200 may be referred to as an operation device because the first server device 200 is capable of performing the operation. In detail, in Equation 1 above, M+e (mod q) has a different value from M+e if q is smaller than M, and it is thus impossible decrypt M+e (mod q). Therefore, a value of q needs to be always greater than M. However, the value of q may be gradually decreased as the operation progresses. Therefore, an operation may be required to change the value of q for the value of q to always be greater than M, and this operation may be referred to as the bootstrapping operation. As the bootstrapping operation is performed, the ciphertext may be made available for the operation again.

As described above, the hybrid allocation method described above may be applied even to the operation process or bootstrapping process for the homomorphic ciphertext. That is, the first server device 200 may also perform the operation of using the GPU in the operation process or bootstrapping process for the homomorphic ciphertext, and use the memory allocation using a dynamic asynchronous method or the memory allocation synchronized with a basic operation during the process.

Meanwhile, FIG. 1 shows a case where the encryption is performed by the first electronic apparatus and the second electronic apparatus, and the decryption is performed by the second server device, and the present disclosure is not necessarily limited thereto.

FIG. 2 is a block diagram showing a configuration of the electronic apparatus according to an embodiment of the present disclosure.

In detail, in the system shown in FIG. 1, the electronic apparatus may refer to not only the apparatus performing the homomorphic encryption, such as the first electronic apparatus or the second electronic apparatus, but also the device performing the operation on the homomorphic ciphertext, such as the first server device, and the device decrypting the homomorphic ciphertext, such as the second server device. The electronic apparatus may be any of various devices such as the personal computer (PC), the laptop, the smartphone, the tablet, or a server.

Referring to FIG. 2, an electronic apparatus 400 may include a communication device 410, a memory 420, a display 430, a manipulation input device 440, and a processor 450.

The communication device 410 may connect the electronic apparatus 400 to the external device (not shown), and may be connected to the external device through a local area network (LAN) or the internet network or through a universal serial bus (USB) port or a wireless communication port (e.g., wireless fidelity (WiFi) 802.11a/b/g/n, near field communication (NFC), or Bluetooth). The communication device 410 may also be referred to as a communication circuit or a transceiver.

The communication device 410 may receive a public key from the external device, and the electronic apparatus 400 may transmit the public key generated on its own to the external device.

In addition, the communication device 410 may receive the message from the external device, and transmit the generated homomorphic ciphertext to the external device. On the other hand, the communication device 410 may also receive the homomorphic ciphertext from the external device.

In addition, the communication device 410 may receive various parameters necessary for generating the ciphertext from the external device. Meanwhile, in implementation, the various parameters may be directly input from the user through the manipulation input device 440 described below.

In addition, the communication device 410 may receive a request for the operation on the homomorphic ciphertext from the external device and transmit its computation result to the external device.

The memory 420 is a component for storing an operating system (O/S), various instructions, software, data, and the like for driving the electronic apparatus 400. Here, the instruction may be an algorithm related to generating, decrypting, or bootstrapping the homomorphic ciphertext, or the like.

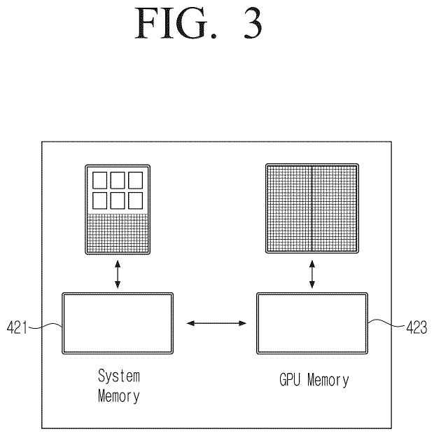

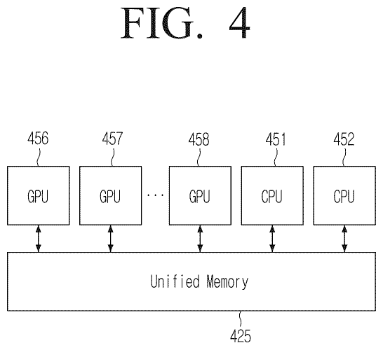

The memory 420 may be implemented in various forms such as a random access memory (RAM), read-only memory (ROM), a flash memory, a hard disk drive (HDD), an external memory, or a memory card, and is not limited to any one of these forms. The memory 420 according to the present disclosure may include a first memory and a second memory. Here, the first memory may be the main memory used by the CPU in the operation process, for example, a dynamic random-access memory (DRAM), and the second memory may be the video memory used by the GPU in the operation process, for example, the VRAM. A detailed configuration of the memory according to the present disclosure is described below with reference to FIGS. 3 and 4.

The memory 420 may store the message to be encrypted. Here, the message may be various credit information, personal information or the like, cited by the user, and may be information related to a usage history such as location information or internet usage time information, used by the electronic apparatus 400.

In addition, the memory 420 may store the public key, and store not only the secret key but also the various parameters necessary for generating the public key and the secret key if the electronic apparatus 400 directly generates the public key.

In addition, the memory 420 may store the homomorphic ciphertext generated in a process described below. In addition, the memory 420 may store the ciphertext transmitted from the external device. In addition, the memory 420 may store the operation result ciphertext which is a result of the operation process described below.

The display 430 may display a user interface window for selection of a function supported by the electronic apparatus 400. In detail, the display 430 may display the user interface window for the selection of various functions provided by the electronic apparatus 400. The display 430 may be a monitor such as a liquid crystal display (LCD) or an organic light emitting diodes (OLED), or may be implemented as a touch screen capable of simultaneously performing a function of the manipulation device 440 described below.

The display 430 may display a message requesting input of the parameter necessary for generating the secret key or the public key. In addition, the display 430 may display a message for selecting a message which is a target to be encrypted. Meanwhile, in implementation, the encryption target may be directly selected by the user or automatically selected. That is, the personal information or the like that requires the encryption may be automatically set even though the user does not directly select the message.

The manipulation input device 440 may receive, from the user, selection of a function of the electronic apparatus 400 and a control command for the corresponding function. In detail, the manipulation input device 440 may receive, from the user, the parameter necessary for generating the secret key or the public key. In addition, the manipulation input device 440 may receive the message set to be encrypted from the user.

The processor 450 may control overall operations of the electronic apparatus 400. In detail, the processor 450 may be connected to the configuration of the electronic apparatus that includes the memory, and control the overall operations of the electronic apparatus by executing at least one instruction stored in the memory as described above. In particular, the processor 450 may be implemented as one processor 450 or as the plurality of processors 450.

The processor 450 may be implemented as a digital signal processor (DSP), a microprocessor, or a time controller (TCON), which processes a digital signal. However, the processor 4500 is not limited thereto, may include at least one of the central processing unit (CPU), a micro controller unit (MCU), a micro processing unit (MPU), a controller, an application processor (AP), the graphics-processing unit (GPU), a communication processor (CP), or an advanced RISC machine (ARM) processor, and may be defined by the corresponding term. In addition, the processor 450 may be implemented in a system-on-chip (SoC) or a large scale integration (LSI), in which a processing algorithm is embedded, or may be implemented in the form of a field programmable gate array (FPGA). In addition, the processor 450 may perform various functions by executing computer executable instructions stored in the memory. Meanwhile, FIG. 2 shows that the electronic apparatus 100 includes only one processor. However, in implementation, the electronic apparatus 100 may include the plurality of processors (e.g., CPU+GPU, CPU+DSP).

The processor 450 may be implemented as least one integrated circuit (or circuitry, IC) chips and may perform various data processing. The processor 450 may include at least one electrical circuit and may individually or collectively distribute and process the instruction (or a program, data, or the like) stored in the memory.

For this operation, the processor 450 may perform the memory allocation to store various information related to the operation in the memory. In addition, the memory allocation may use the dynamic allocation method in which the allocation is changed dynamically based on an operation state of the electronic apparatus 100 rather than using one method. Alternatively, in implementation, the processor 450 may use a static allocation method.

That is, the processor 450 may determine the allocation method to be performed based on a stream in the process for a task such as the generation/operation/decryption for the homomorphic ciphertext. In addition, the processor 450 may perform the memory allocation by using the determined allocation method.

For example, the processor 450 may use, as the dynamic allocation method, a first memory allocation method for basically allocating GPU memory regions in the stream order related to the homomorphic operation. In addition, the processor 450 may use a second memory allocation method synchronized with the operation of the device if the GPU memory region occupies a certain level of usage or more, and the operation on a longer-lifespan object is in progress rather than shorter-lifespan objects are repeatedly re-allocated. In case of using the second memory allocation method, the processor 450 may use not only the GPU memory (e.g., VRAM) but also CPU memory region (e.g., DRAM) as an allocation region.

First, a “synchronization processing method” described below indicates a method of waiting for a GPU response for each computation if a CPU program requests a series of computation tasks to the GPU. In addition, an “asynchronous streaming processing method” indicates a method of streaming an asynchronous request without waiting the response for each computation, as opposed to the synchronization processing method.

In addition, a cudaMallocAsync method indicates a method of allowing the CPU program to make the asynchronous request a GPU VRAM allocation. Meanwhile, in implementation, the processor 450 may use another method in addition to the above-described methods.

The cudaMallocManaged method indicates a method of managing the CPU main memory and the GPU VRAM as a unified virtual memory without distinguishing therebetween. In implementation, the processor 450 may use another method in addition to the above-described methods.

Meanwhile, a unified management allocation provided by a GPU manufacturer may be an infrastructure not only for reducing a burden on a programmer to manually manage the GPU memory but also for allowing usage of a host memory as an auxiliary resource (the allocation exceeding a physical size of the VRAM, OverSubscription) even if the GPU memory is insufficient.

Therefore, there is a need to provide a solution that allows the homomorphic encryption application to be executed without interruption even on the low-specification GPU by basically using this function.

Meanwhile, the fastest implementation is to manually suppress the asynchronous allocation and deallocation operations themselves on the GPU memory as much as possible if the GPU has sufficiently high specifications and there is thus no memory shortage and the programmer is well-versed in his/her program.

On the other hand, the performance may be significantly degraded compared to the manually optimized asynchronous allocation method if all the GPU memory allocations are delegated to the unified management allocation infrastructure.

In this regard, in the present disclosure, the processor 450 may use three methods to prevent the performance degradation by the unified management allocation method while being operable even on the low-specification GPU.

The first method may be a “static hybrid”. In consideration of a feature of a homomorphic encryption library, the unified management allocation may implement information advantageous to reside in the memory because the information is always used in the GPU acceleration kernel computation, and the asynchronous allocation may implement the object temporarily generated during the computation process and having a shorter lifespan period. In some cases, the first method may achieve the performance close to that of the manual asynchronous allocation method. However, the first method may not be sustainable because this method requires to modify the homomorphic encryption library at a low level (invasive).

The second method may be a “profile-based static hybrid”. The method of directly analyzing the inside of the homomorphic encryption library and pre-mixing the two methods for allocating the memory in a heuristic manner may have significantly improved efficiency based on a specification of the GPU owned by the user and a type of the homomorphic encryption application. Inspired by techniques familiar in the field of compilers, data profiling facilities are added to a GPU memory management container of the homomorphic encryption library and to pre-profile a target application.

The second method may process the identification (ID), size, timestamp, and lifespan period information of the GPU allocation object, which are acquired here, in an offline manner, calculate a threshold value (asynch peak threshold) candidate set for the asynchronous allocation, and measure a performance improvement rate for each candidate set. As a result, the second method may be a method that yields the highest performance on the low-specification GPU.

The third method may be a “dynamic hybrid”. The method of determining a allocation strategy through static profiling may be useful for a repeatedly executed application where throughput is important. However, this method may be slightly burdensome to be used in a one-shot application. An algorithm for dynamically selecting the object allocation method without any prior task is as follows.

In detail, the allocation size may be the only information that the processor 450 is capable of acquiring from the memory allocation request generated in real time while the program is executed, and the processor 450 may thus prepare a key-value map having the allocation size as the key and the number of active objects in an allocated state as a value.

In addition, in response to the map, the processor 450 may separately prepare an N-sized list for recording a history of changes in the number of active objects each time the objects are allocated for each size. For example, if N is 10 and an S-sized object is allocated 10 times without being deallocated, the list corresponding to S may record 1, 2, 3, 4, 5, 6, 7, 8, 9, and 10. Next, if the object is deallocated 3 times and then allocated again, the list may record 2, 3, 4, 5, 6, 7, 8, 9, 10, and 8.

In addition, the processor 450 may perform the allocation of the corresponding-sized objects in a unified management mode until the N-sized list corresponding to S is fully used.

If the history accumulates beyond N times, the processor 450 may allocate new objects of the corresponding size in an asynchronous allocation mode in case that a difference between the minimum and maximum values in the list is less than X, which is determined in the heuristic manner, and in a unified management allocation mode in case that the difference is X or more. The reason is that an object having a relatively frequent allocation and return has the shorter-lifespan period, and an overhead tends to be very large if this object is allocated using the unified management.

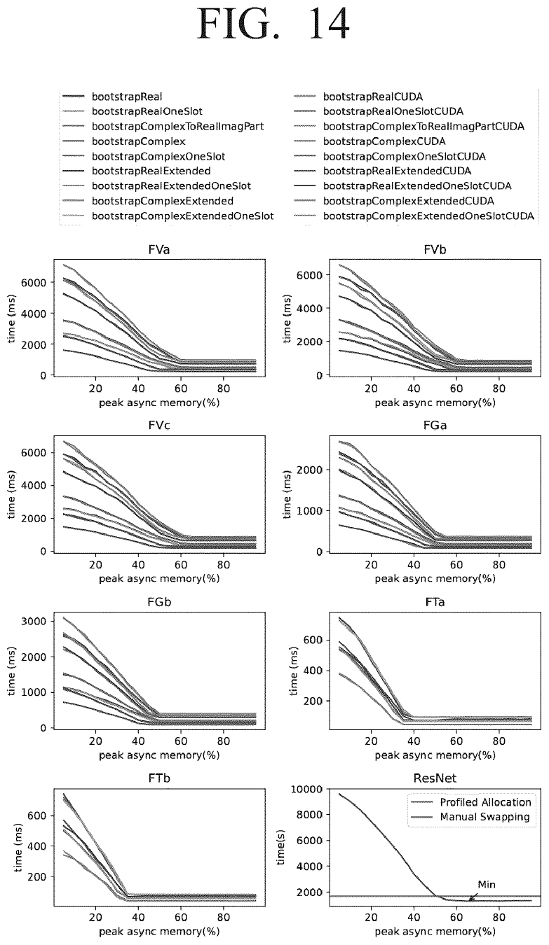

The description below describes the operation as “the dynamic allocation method” for ease of description, and in implementation, the processor may use another allocation method described above. More details of the method for allocating a memory are described below with reference to FIGS. 3 through 16.

The processor 450 may process a set value, a function instruction, or the like based on the pre-stored control program or control data, and output a control signal related to a function that the electronic apparatus may perform or a communication signal for communication of the electronic apparatus with an external electronic apparatus.

In case of receiving the message to be transmitted, the processor 450 may store the same in the memory 420. The processor 450 may homomorphically encrypt the message by using various set values and programs stored in the memory 420. In this case, the processor 450 may use the public key.

The processor 450 may generate and use the public key necessary to perform the encryption on its own, or may receive the public key from the external device and use the same. As an example, the second server device 300 performing the decryption may distribute the public key to another device.

In case of generating the key on its own, the processor 450 may generate the public key by using a ring-LWE scheme. To describe in detail, the processor 450 may first set the various parameters and rings, and store the same in the memory 420. Examples of the parameters may include a bit length of a plaintext message, a size of the public key, a size of the secret key, and the like.

The ring may be expressed by the following equation.

$$R = {Z}_{q} [ X ] / f ( x ) \qquad [ Equation 2 ]$$

Here, R indicates the ring, Z_{q} indicates a coefficient, and f (x) indicates an N-th polynomial.

The Ring indicates a set of polynomials having predetermined coefficients, and indicates the set in which addition and multiplication are defined between elements and are closed for addition and multiplication. The Ring may be referred to as the ring.

As an example, the ring indicates a set of the N-th polynomials having the coefficient Z_{q}. In detail, if n is Φ(N), the polynomial indicates a polynomial which may be calculated as the remainder of dividing the polynomial by an N-th cyclotomic polynomial. (f(x)) indicates ideal of Z_{q}[x] generated by f(x). The Euler totient function Φ(N) indicates the number of natural numbers that are coprime to N and smaller than N. If ΦN(x) is defined as the n-th cyclotomic polynomial, the ring may also be expressed in Equation 3 as follows.

$$R = {Z}_{q} [ X ] / {Φ}_{N} ( x ) \qquad [ Equation 3 ]$$

The secret key sk may be expressed as follows.

Meanwhile, the ring of Equation 3 described above has a complex number in a plaintext space. Meanwhile, only a set in which the plaintext space includes a real number among the sets of rings described above may be used to improve an operation speed for the homomorphic ciphertext.

If the ring is set in this way, the processor 450 may calculate the secret key sk from the ring.

$$sk ← ( 1 , s ( x ) ) , s ( x ) ∈ R \qquad [ Equation 4 ]$$

Here, s (x) indicates a random polynomial generated using a small coefficient.

In addition, the processor 450 may calculate a first random polynomial a (x) from the ring. The first random polynomial may be expressed as follows.

$$a ( x ) ← R \qquad [ Equation 5 ]$$

In addition, the processor 450 may calculate the error. In detail, the processor 450 may extract the error from a discrete Gaussian distribution or a distribution having a statistical distance close thereto. This error may be expressed as follows.

$$e ( x ) ← {D}_{α q}^{n} \qquad [ Equation 6 ]$$

If even the error is calculated, the processor 450 may calculate a second random polynomial by modularly operating the error on the first random polynomial and the secret key. The second random polynomial may be expressed as follows.

$$b ( x ) = - a ( x ) s ( x ) + e ( x ) ( mod q ) \qquad [ Equation 7 ]$$

Finally, a public key pk may be set to include the first random polynomial and the second random polynomial as follows.

$$pk = ( b ( x ) a ( x ) ) \qquad [ Equation 8 ]$$

The method for generating the key described above is only an example, the present disclosure is not necessarily limited thereto, and the public key and the secret key may be generated by another method.

Meanwhile, if the public key is generated, the processor 450 may control the communication device 410 to transmit the generated public key to another device.

In addition, the processor 450 may generate the homomorphic ciphertext for the message. In detail, the processor 450 may generate the homomorphic ciphertext by applying the previously-generated public key to the message. Here, the processor 450 may generate the ciphertext to have a length corresponding to a size of the scaling factor.

In addition, if the homomorphic ciphertext is generated, the processor 450 may store the homomorphic ciphertext in the memory 420, or control the communication device 410 to transmit the homomorphic ciphertext to another device based on the user request or a predetermined default instruction.

Meanwhile, according to an embodiment of the present disclosure, the processor 450 may use packing. The processor 450 may encrypt the plurality of messages into one ciphertext if the packing is used in the homomorphic encryption. In this case, if the electronic apparatus 400 performs the operation on each of the ciphertexts, an operation burden may be greatly reduced as a result because the operations on the plurality of messages are processed in parallel.

In detail, if the message includes a plurality of message vectors, the processor 450 may convert the plurality of message vectors into a polynomial for encrypting the message vectors in parallel, then multiply the polynomial by the scaling factor, and use the public key to thus perform the homomorphic encryption. Accordingly, the processor 450 may generate the ciphertext by packing the plurality of message vectors.

In addition, if the decryption is necessary for the homomorphic ciphertext, the processor 450 may apply the secret key to the homomorphic ciphertext to thus generate a decrypted text in the polynomial form, and decode the decrypted text in the polynomial form to thus generate the message. Here, the generated message may include the error as mentioned in Equation 1 described above.

In addition, the processor 450 may perform the operation on the ciphertext. In detail, the processor 450 may perform the operation such as the addition or the multiplication on the homomorphic ciphertext while maintaining an encrypted state.

Meanwhile, if the operation is completed, the processor 450 may detect data in the effective region from operation result data. In detail, the processor 450 may detect the data in the effective region by performing rounding processing on the operation result data. The rounding processing may refer to rounding off the message in the encrypted state, and may also be referred to as rescaling. In detail, the processor 450 may remove a noise region by multiplying each component of the ciphertext by A-1, which is a reciprocal of the scaling factor, and rounding off the same. The noise region may be determined to correspond to the size of the scaling factor. As a result, the processor may detect the message in the effective region excluding the noise region. An additional error may occur because the operation is performed in the encrypted state. However, this error may be ignored because its size is sufficiently small.

In addition, if the approximate message weight in the operation result ciphertext is more than the threshold value, the processor 450 may perform the bootstrapping operation on the ciphertext. Here, the processor 450 may perform the bootstrapping operation using various methods. For example, the processor 450 may perform the bootstrapping operation through processes of expanding the modulus of the operation result ciphertext, performing a first linear transformation on the homomorphic ciphertext having the expanded modulus into the polynomial form, performing an approximation operation on a first homomorphic ciphertext transformed into the polynomial form by using a function that is set to approximate a modulated range of the plaintext, performing a second linear transformation on a second homomorphic ciphertext approximated into a form of the homomorphic ciphertext.

Meanwhile, the bootstrapping operation may consume a lot of operation resources, and this task may be performed using the GPU. That is, the operation may be performed using the GPU as an accelerator, and use a relatively large memory region.

As described above, the bootstrapping may consume the relatively large memory region, thus making it impossible for a conventional electronic apparatus having a small GPU memory to perform the bootstrapping operation. However, the electronic apparatus 400 according to an embodiment of the present disclosure may use a technology that uses the CPU memory as well in case of processing the operation using the GPU, thus performing the bootstrapping operation regardless of the size of the GPU memory. In addition, the electronic apparatus according to the present disclosure may use a method of using not only the CPU memory but also the GPU memory by integrating the same, thus allowing an algorithm developer of the homomorphic ciphertext to more easily generate the algorithm.

FIG. 3 is a diagram showing the memory configuration according to the present disclosure.

Referring to FIG. 3, the memory 420 may include a first memory 421 and a second memory 423. An example in the drawing shows only the two memories, and in implementation, three or more memories may be used.

The first memory 421 may be the memory used to temporarily store the data in the electronic apparatus. The first memory 421 may be referred to as the RAM, the DRAM, the CPU memory, a basic memory. The first memory 421 may be used to temporarily store information necessary for performing a task using the operating system, the program, or a document.

The second memory 423 may be the memory used by the GPU, and may be referred to as the VRAM, the video memory, or the like. The second memory 423 may be used not only for performing a task such as two-dimensional (2D) or three-dimensional (3D) graphics or video/image processing but also for processing the operation on the homomorphic ciphertext.

In this way, the first memory 421 and the second memory 423 may be physically separated from each other by a peripheral component interconnect express (PCIe) bus. Conventionally, the first memory 421 and the second memory 423 may be managed individually.

That is, a region in the first memory 421 and a region in the second memory 423 may be conventionally required to be managed separately, and data in a specific storage region within the first memory 421 may be required to be moved to the second memory 423 even in case that a user device of the same data is changed, for example, changed from the CPU to the GPU. The opposite case may also be possible.

Therefore, if the first memory 421 and the second memory 423 are separately managed, the memory may be required to be explicitly managed while copying the data between the CPU and GPU. In addition, each access method may be complex and error-prone because the method requires careful tracking of the memory allocation and deallocation on both the memories.

Meanwhile, the homomorphic ciphertext may require a relatively large GPU memory if the GPU is used to accelerate the operation on the homomorphic ciphertext. Accordingly, a graphics card having a graphic memory of 8 gigabytes (G) or more may be conventionally used for the homomorphic operation task. That is, a memory shortage may occur in case of using a graphics card having a graphic memory of less than 8 G. In this regard, it is difficult to use an inexpensive graphics card for the homomorphic ciphertext operation.

The unified memory may be used to solve the memory shortage. The unified memory is described below with reference to FIG. 4.

FIG. 4 is a diagram showing the method for allocating a memory according to an embodiment of the present disclosure.

FIG. 4 shows a unified memory 425. The unified memory 425 according to the present disclosure is described assuming a CUDA unified memory supported by NVDIA. However, in implementation, the unified memory 425 may use any method that unifies the RAM with the VRAM.

The unified memory 425 may generate a managed memory pool and connect GPUs 456, 457, and 458 and CPUs 451 and 452 to the pool. The memory 425 may be accessed from both the CPUs 451 and 452 and the GPUs 456, 457, and 458 by using one pointer.

The unified memory 425 may automatically move the data allocated to the corresponding memory between a host and the device, thus making the corresponding memory appear as the CPU memory if the operation is performed by the CPU, and as the GPU memory if the operation is performed by the GPU.

The data movement between the CPU and GPU may be managed automatically if the unified memory 425 is used in this manner. This management method is referred to as a second allocation function (CudaMallocManaged) below. The second allocation function may provide a single memory allocation function that is accessible from both the CPU and the GPU.

The unified memory may simplify a memory management, reduce code complexity, and improve GPU programming productivity. In addition, the developer may focus on the algorithm for processing the homomorphic ciphertext instead of a complex memory management. In addition, the same memory allocation function and pointer may be used across a variety of CUDA-enabled devices without any modification.

Although the unified memory offers convenience and ease of use, it is very important to consider an impact on performance of the unified memory. For example, the overhead may occur if the data is frequently moved between the CPU and GPU. In addition, it is necessary to carefully consider an access pattern, the memory usage, and a synchronization point to optimize performance of an application that uses the unified memory.

First, the description describe the method for allocating a memory in a conventional stream order. Hereinafter, the first allocation method refers to the asynchronous method for allocating a memory in the stream order.

Among first allocation functions, cudaMallocAsync indicates an extension of a cudaMalloc function used to allocate the memory by the GPU. Hereinafter, the description describes cudaMallocAsync assuming cudaMallocAsync is supported by NVDIA. However, in implementation, another method may be applied instead of the example described above if there is another method for allocating a memory in the stream order other than the first allocation method.

The first allocation function may asynchronously allocate the memory in the stream order, and accordingly, the GPU may not be blocked until the memory allocation is completed.

This asynchronous feature may improve overall performance and resource usage of the GPU by performing the memory allocation in the stream order. That is, the GPU may continue its processing or computation by using the allocated memory without waiting for the entire GPU device to be synchronized while the memory is allocated.

Meanwhile, it may be conventionally required to allocate the large memory region to pre-allocate the memory and reuse the memory, which may cause bugs and increase the code complexity.

However, this new task may provide a user-friendly interface to thus increase the productivity and eliminate any need for a custom memory allocator.

A function of the first allocation function may receive the memory size to be allocated and a CUDA stream as its input parameters. Here, the CUDA stream indicates a sequence of instructions executed sequentially by the GPU. That is, the developer may control the order and synchronization of the GPU task by associating the memory allocation with a specific stream.

This first allocation function may not guarantee immediate memory allocation. Instead, the memory allocation process may be started asynchronously in the stream order. For example, a memory driver may generate the memory pool. The operating system may allocate the memory based on the threshold value set based on this memory pool.

A synchronization mechanism such as cudaStreamSynchronize or an event-based synchronization call may automatically return an unused memory to the operating system, and maintain the memory in the memory pool unless a specific threshold value is set. Therefore, it is possible to provide much faster memory allocation performance by using the first allocation function.

However, it is necessary to consider an accurate memory usage or the like for the memory allocation in this way. In this regard, the description describes various factors of the homomorphic ciphertext that affect the memory size as follows.

Security parameter: a memory requirement may depend on the security parameter (e.g., modulus size, ciphertext size, or desired security level). For example, the larger security parameter may increase the memory usage.

Table I shows brief information on a parameter size in the homomorphic ciphertext library used in the present disclosure. N indicates the number of slots in the ciphertext, and Q indicates log (Q)=log Πqᵢ (here, i belongs to [1, n]), which is a set of prime numbers q1, q2, . . . , and qn. |?| indicates the number of elements in the set. All the parameters may have a security level of 128 bits or higher. The larger a value of N, the more memory the corresponding parameter may consume.

TABLE 1

| Parameter | N | log₂(Q) | \|Q\| |
|---|---|---|---|
| FVa | 2¹⁷ | 2070 | 40 |
| FVb | 2¹⁷ | 2292 | 40 |
| FVc | 2¹⁷ | 2341 | 40 |
| FGa | 2¹⁶ | 1555 | 28 |
| FGb | 2¹⁶ | 1555 | 30 |
| FTa | 2¹⁵ | 777 | 22 |
| FTb | 2¹⁵ | 771 | 17 |

Ciphertext size: the ciphertext size may affect the memory usage. The larger the ciphertext size, the more memory may be required to store and manipulate the encrypted data. The ciphertext size may depend on an application requirement and the precision or granularity required for the computation.

Encryption key: the number of encryption keys may also affect the memory usage. For example, an additional key may be necessary for the bootstrapping task or another encryption task. The size and associated metadata of the key may contribute to the overall memory requirements.

Intermediate computation: the plurality of homomorphic operations may be performed on the encrypted data in some cases. As the intermediate computation progresses, a new ciphertext may be generated or noise may be accumulated to thus increase the memory usage. Efficient management of an intermediate ciphertext and a noise reduction technique may assist in optimizing the memory usage.

Bootstrapping: the bootstrapping indicates the homomorphic operation process for expanding the plaintext space of the ciphertext to reduce accumulated noise. In general, the bootstrapping may require a lot of memory resources, because the bootstrapping requires storing and manipulating a large polynomial representing the ciphertext.

These items may be independently related to each other, and each item may be increased to thus increase a required memory size.

Hereinafter, the description examines the memory allocation in case of using a CKKS scheme which is one of the homomorphic encryption methods used in the present disclosure. However, in implementation, the present disclosure may also use the homomorphic encryption method using another scheme other than the CKKS scheme.

The CKKS scheme may include three types of data. The respective types may be the message, the plaintext, and the ciphertext.

Here, the message may be stored as a complex number array. In addition, the plaintext may be transformed into a form enabling the plaintext to be easily encrypted by encoding and decoding the same using a number theoretic transform (NTT) polynomial before encrypting the message. In addition, the ciphertext may be an encrypted plaintext which may only be decrypted using the corresponding secret key.

Each parameter set may determine the security level and the number of slots in the ciphertext, and requires a different type of key set depending on the task performed on the ciphertext. Therefore, the memory usage may greatly depend on the parameter used for the memory usage.

Further, a faster transformation may also require a set of constant values that need to be transmitted to the GPU memory to perform the computation. The constant value may consume more GPU memory depending on the set of parameters used therein. The present disclosure uses various sets of parameters for the task described above.

Hereinafter, the description describes various methods for allocating a memory based on the conditions described above.

First, the method may only use the first allocation function. In this case, the memory allocation may be limited to the maximum GPU size even though a delay in the memory allocation process is small.

In addition, the method may only use the second allocation function. This method may ensure that the memory usage is not limited even to a capacity of a secondary storage device if the memory usage uses a capacity of a host DRAM or that of a swap memory.

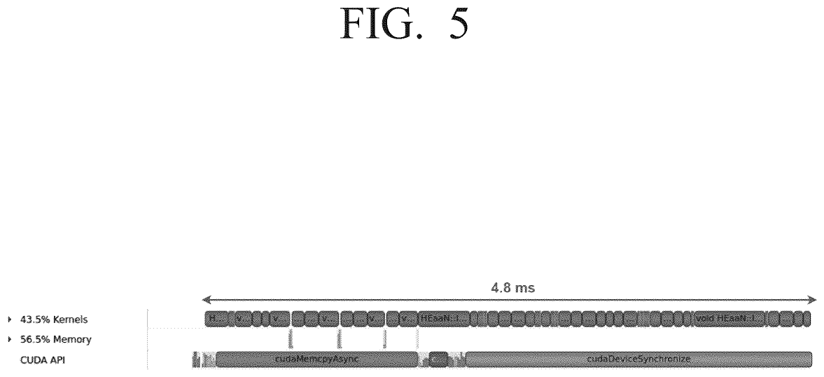

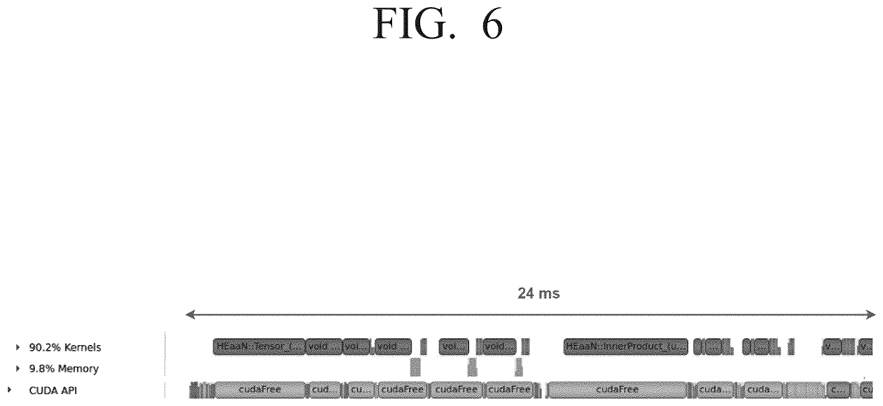

However, the performance degradation may occur in case of using only use the second allocation method. This configuration is described below with reference to FIGS. 5 and 6.

FIG. 5 is a diagram showing an operation example in case of using the asynchronous allocation method. In addition, FIG. 6 is a diagram showing an operation example in case of using the synchronous allocation method.

Referring to FIG. 5, an operation waiting time of approximately 4.8 ms in case of using the first allocation method to thus allocate the memory.

On the other hand, referring to FIG. 6, it may be seen that the operation waiting time may be increased in case of using only the second allocation method by approximately 24 ms, which is 5 times compared to the case of using only the first allocation method. This overhead may occur even if the memory is not overused.

As described above, the second allocation method may prevent the memory shortage. However, it may be seen that the operation waiting time may be increase to affect the operation speed.

It may be seen that the kernel is executed simultaneously with a cudaFree CUDA application programming interface (API) as a result of examining the operation using the second allocation method in detail to confirm this problem of the second allocation method.

The operation performed in this way may cause the performance degradation because the operation causes the synchronization of the entire apparatus after each call. In detail, cudaFree may be implicitly called if the code is out of a code range, and allocating a temporary variable in the middle of the code may thus cause the performance degradation.

The present disclosure considers various methods to resolve the performance degradation.

First, the present disclosure considers a method to reuse a temporary buffer after each operation to prevent the buffer from being deallocated. However, this method may lead to an error-prone code that handles double pointers, and cause the delay because the buffer is still allocated in a first iteration.

The present disclosure considers another method for allocating the temporary buffer by using the first allocation function (cudaMallocAsync) and allocating another buffer by using the second allocation function. For example, a second allocation method may be added to a general buffer allocator of the homomorphic ciphertext library, and all the temporary buffers may be allocated using an additional flag to perform the asynchronous allocation.

In this way, other techniques of the unified memory may be used, such as setting the constant value to read-only (cudaMemAdvise), forcing the constant value to reside in a GPU memory buffer by using a SetPreferredLocation flag, or the like.

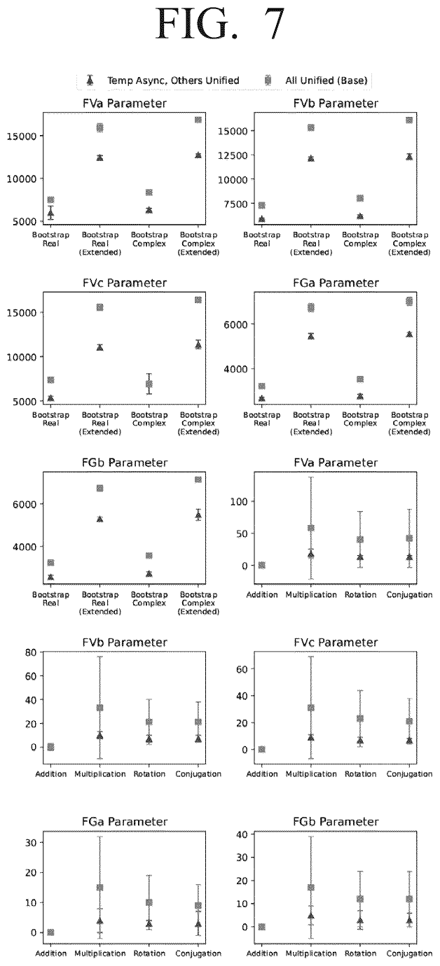

The operation delay time may be reduced to a level similar to a case where all the buffers are allocated completely and asynchronously by using this method. FIG. 7 shows an experimental result in case of using this method. This allocation method may be referred to as the static hybrid method.

FIG. 7 is a diagram showing a memory allocation delay time based on the two allocation methods.

Referring to FIG. 7, the bootstrapping at all the parameter sizes may use more than 2 gigabytes (GB) of the VRAM. It may be seen that in another operation, the GPU memory is overused for an FVx parameter, and not for another parameter size.

The hybrid access method for asynchronously allocating the temporary buffer and allocating another memory object in a unified manner may have a lower delay time than a full unification-allocation access method.

For example, the delay time for the addition operation may be very small to thus be ignored for both the access methods. In addition, it may be seen that another operation such as the multiplication, rotation, or conjugation have a wider change range of the delay time compared to a basic unification case in each iteration, while the asynchronous allocation case has a more stable and lower delay time.

In summary, it may be seen from the experiment that the two methods for allocating a memory may be combined with each other even though the delay time is unable to be reduced to the same extent as the case of allocating the memory completely and asynchronously.

Therefore, the present disclosure uses an allocation method of combining the two allocation methods described above. However, the combination method may be diverse, and the description below describes which method to use for the combination.

First, the description describe the memory allocation ratio for determining the optimal ratio.

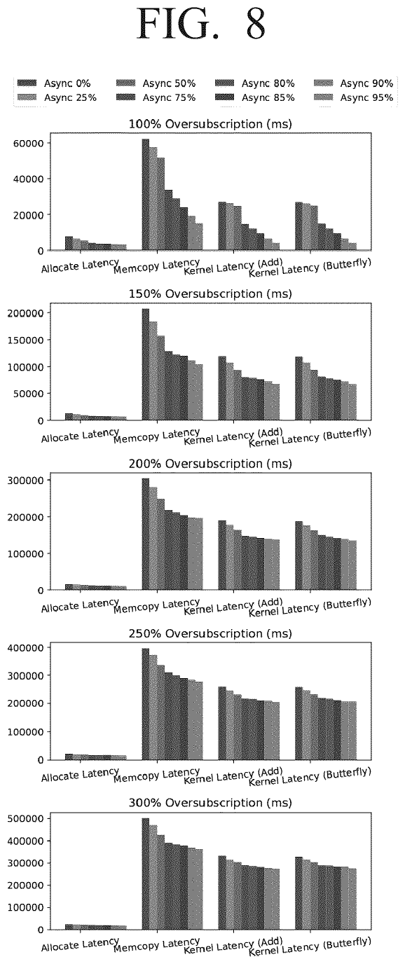

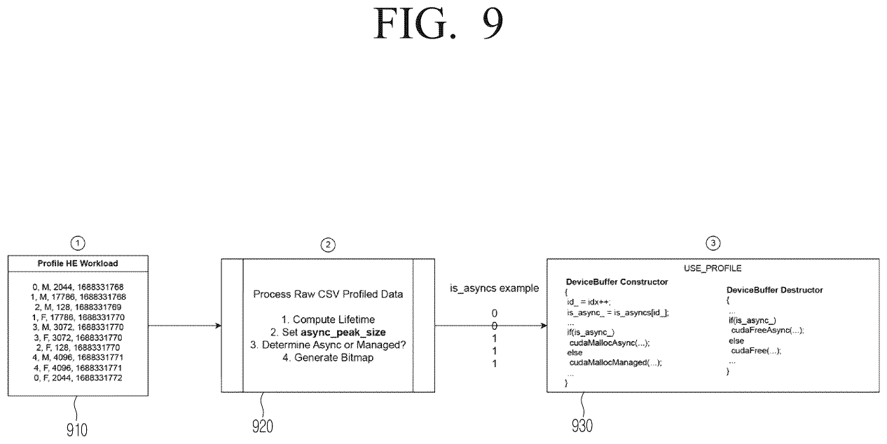

To determine this final ratio, various experiments are conducted, and their experimental results are described below with reference to FIGS. 8 and 9. The experiments use a test CUDA program.

FIGS. 8 and 9 show the experimental results to verify the memory allocation ratio.

Referring to FIG. 8, each subgraph shows a ratio of mixing the managed memory with the asynchronous allocation to a total GPU memory capacity available. The maximum capacity available for the asynchronous allocation may be 100%. (The maximum capacity may actually be about 95% usable, and the memory shortage may occur if the usage reaches about 95% or more due to a fixed memory size required for a CUDA driver).

Therefore, the experiments are performed using the asynchronous allocation having each ratio of 0%, 25%, 50%, 75%, 80%, 85%, 90%, or 95%. If a usage value is more than 100%, the remaining memory is allocated to cudaMallocManaged. The allocation delay time, memory copy delay time from the host to the apparatus, and a kernel delay time for performing two different operations are measured. One of the two operations is a simple random addition, and the other is an 8-point butterfly operation used in a fast Fourier transform (FFT) algorithm.

To perform the 8-point butterfly operation, pages are allocated in 4 KB chunks and pointers pointing to the respective chunks are randomly shuffled. The addition or a butterfly kernel is then executed.

As shown in FIG. 8, the higher the asynchronous allocation ratio, the longer the time for all the operations. However, as an over-utilization rate is increased, each operation may have significantly lower performance.

The over-utilization rate of 100% may indicate that the data occupies the entire available memory of the GPU at one time. The over-utilization rate of 100% or more indicates that the data is not fully accommodated in the GPU.

It may be seen that if the over-utilization rate is 200% (i.e., if the data is twice a total GPU memory size), the operation delay time is almost an order of magnitude greater compared to a case where the data is able to be fully accommodated in the GPU.

This difference occurs due to a page fault that occurs in case of using the CUDA unified memory. However, maintaining the asynchronous allocation mode provides the highest performance for all the operations, even if the over-utilization rate becomes high. Therefore, in the present disclosure, the allocation method uses the above-described method.

Hereinafter, the description describes the hybrid method that uses the profiling. This method may be referred to as a profiling allocation scheme.

Manually inserting an explicit allocation instruction such as allocate_async( ) may be tedious to apply to all the GPU objects in a frequently maintained code base such as a HEaaN library. Here, the HEaaN library indicates a library that implements the CKKS scheme described above.

Due to design of the HEaaN library, most allocated objects, excluding the temporary buffer, may be implicitly allocated using the general memory buffer allocator.

To this end, the programmer may be required to statically generate an exception for all the GPU buffers in a library code, which may depend on a location where the object is automatically deallocated if the object is out of the range.

Changing the code by considering all these cases is tedious and bug-prone, and statically modifying the allocation method for each object may result in variable runtime performance based on a specific GPU hardware used therein.

As a result, the library code base may be required to be modified in a very invasive way. Implementing a large-scale application using the HEaaN library may also require an additional object that the user inserts, such as a temporary ciphertext, if necessary.

This configuration may be an additional disadvantage of the static method because the user of the library is required to know which allocation method to use. Therefore, instead of the static method, a minimally-invasive dynamic method is preferred, where the programmer or the user does not need to worry directly about which allocation method to use for every GPU object.

Important details about whether the object needs to be allocated asynchronously may be acquired in case of profiling the homomorphic task at runtime. This configuration may be based on the fact that the memory allocation used in the present disclosure has a large overhead in the apparatus synchronization, and the shorter-lifespan GPU object is thus required to be allocated asynchronously.

FIG. 9 is a diagram showing the profiling allocation scheme according to an embodiment of the present disclosure.

Referring to FIG. 9, the entire homomorphic encryption task may first be executed one time while a profiler is activated (910). In detail, the data such as the ID, allocation or deallocation, data size, timestamp, or the like of the GPU object may be collected.

After collecting the data, store the same in a comma-separated values (CSV) file and execute a python script to thus process a raw CSV format (920). At this stage, the python script may use the timestamp and ID of each GPU object as an identifier to compute the lifespan of the corresponding object based on its allocation and deallocation time points. In addition, the threshold value, i.e., asynchronous peak threshold value may be determined to determine the maximum data amount selected for the asynchronous allocation by the GPU.

The GPU data may be organized based on the lifespan of every GPU object in an ascending order. Next, N, which is an upper limit of the lifespan of the GPU object (in seconds) to be asynchronously allocated may be selected.

The data may then be stored in the order of the GPU ID, thus allowing the managed memory allocation to be marked as 0, and the asynchronous allocation as 1.

In addition, the profiled data may be used to appropriately allocate each GPU object in all subsequent passes (930). The object allocation order may not be changed in the subsequent passes, and this profiling scheme may thus be used as an “oracle” to thus determine the optimal allocation selection for all the subsequent passes. Performing this scheme may be suitable for a task that requires repeated execution.

The present disclosure evaluates performance of this scheme by using two different tasks to verify the same. First, the first task is the bootstrapping task, which is a lightweight task that uses less memory.

This task may be referred to as a brakerski-malavolta (BM)-bootstrap, and is a task that is used to test all the other bootstrapping tasks across all the parameter sizes. The other task is a homomorphic encryption (HE)-assisted pre-trained ResNet-20 using a modified national institute of standards and technology (MNIST) for inference.

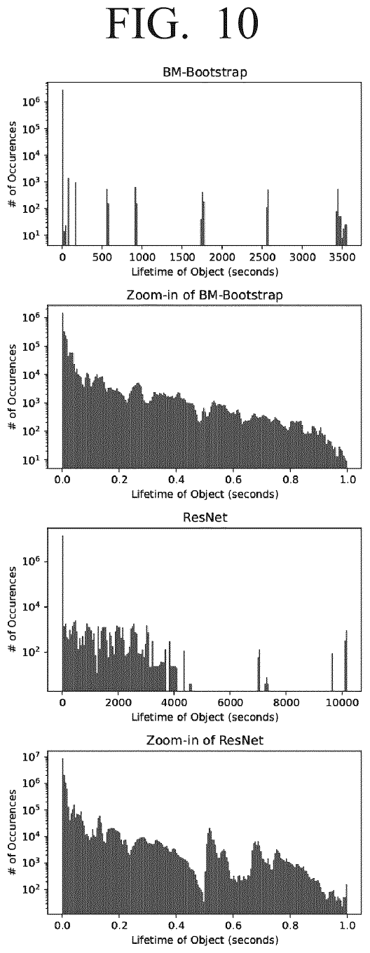

This performance verification is described below with reference to FIGS. 10 to 12.

FIG. 10 is a graph showing the number of occurrences based on a lifespan of each object.

Referring to FIG. 10, the lifespan of every object for the BM-bootstrap and ResNet-20 tasks may be checked. The first and third graphs show the number of occurrences of an object whose lifespan is less than 1 second on a log scale. The reason is that the above object constitutes the majority of all the objects.

In both the tasks, most of the GPU objects have the lifespan of less than 1 second, which constitutes about 92% of all the GPU objects in the BM-Bootstrap.

Therefore, if N=1 is set as a lifespan threshold value of an object in this range or below, a value of 1 may be assigned to indicate that the objects are allocated in the asynchronous allocation mode (here, 0 indicates the allocation in the managed mode). After the first second, the number of occurrences of different lifespans may be greatly changed. Second and fourth subplots show these objects and their lifespans.

For the BM-Bootstrap, changing the parameter while continuously executing the task explains why the longer-lifespan object is changed, resulting in intermittent spikes in a first subplot.

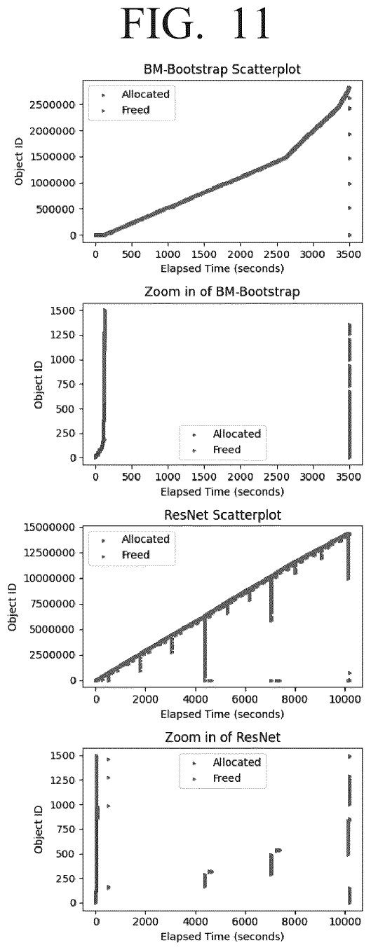

FIG. 11 shows a scatter plot illustrating the lifespans of all the GPU objects in a full view and a zoomed-in view.

Referring to FIG. 11, an allocation point is marked in green, a freed point in red, and an arrow in an opposite direction is marked as a marker as shown in a graph legend. For the BM-bootstrap, the allocation and freed points are executed continuously until the program ends. Most of the objects are deallocated as soon as the objects are allocated.

However, there are a few objects that are not deallocated until the program ends, as indicated by rare red dots at a graph end. If the object ID in a second subplot is zoomed-in to a range of 1,000, it may be seen that some objects are not deallocated until the program ends.

This phenomenon is also true for ResNet. However, ResNet shows a point where a specific object is more variable than in the bootstrapping task. This difference shows that each task has different allocation and deallocation timings and each object has a different lifespan.

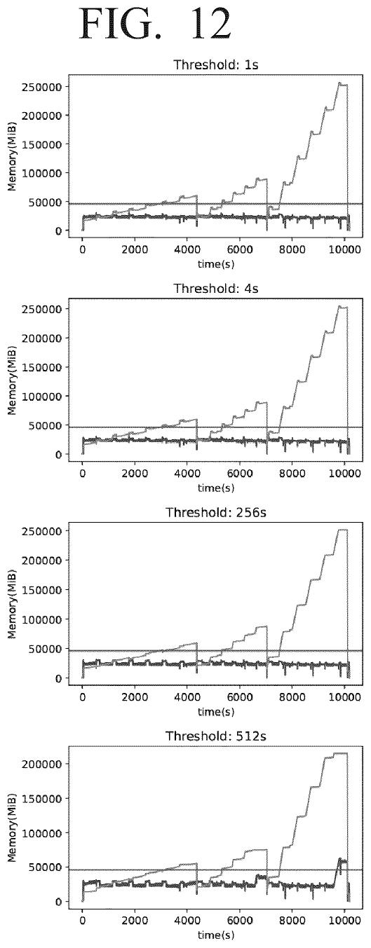

FIG. 12 is a diagram showing the maximum memory usage of the GPU object. In detail, FIG. 12 shows the memory usage of the memory object in case that the object is allocated using cudaMallocAsync and uses CudaMallocManased.

Referring to FIG. 12, the threshold value may be the N value for the lifespan of the object set to be allocated asynchronously. A blue line indicates the maximum memory usage of the object allocated asynchronously at a corresponding time point during the task execution. An orange line indicates the maximum memory usage of the managed memory. A red line indicates the maximum available GPU memory of the apparatus. The accelerator used here is an A40 GPU having a total usable memory of 48 GB.

As shown in FIG. 12, it may be seen that up to N=256, the asynchronous allocation does not use more memory than is physically available, and if the lifespan threshold value becomes 512, the memory is used more than the physically usable GPU memory, which may result in the memory shortage error.

Such a method is not truly dynamic because the optimization is possible only after the task completes its initial execution.

Using the profiling scheme may not provide much benefit if the task is long-running and only executed once. Hereinafter, the description describes the dynamic method that adjusts the allocation method in real time for all the GPU objects without prior knowledge.

The performance may be improved using this method without any overhead in the profiling or codebase changes.

The present disclosure uses the fact that the shorter-lifespan objects are repeatedly re-allocated as the program progresses.

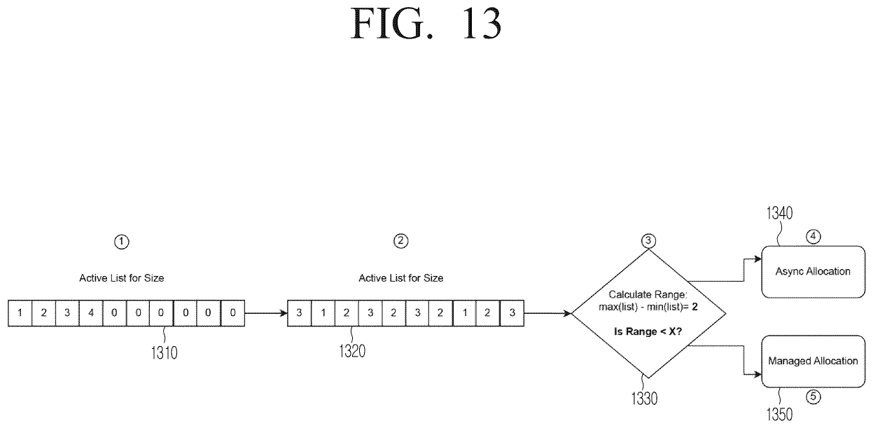

If the object is re-allocated, it is possible to determine whether the object is to be allocated asynchronously or allocated to the unified memory through the process of determining the allocation method. Accordingly, the allocation method may be dynamically adjusted, instead of changing the pointer allocation or transmitting the memory. Details of the dynamic allocation method are described below with reference to FIG. 13.

FIG. 13 is a diagram showing the dynamic allocation method according to the present disclosure.

Referring to FIG. 13, the only information provided in case of allocating the memory may be the size of the object, and it is thus possible to maintain a map having the allocation size as the key and the number of active allocations and ten active lists as its values (1310).

The number of active allocations of a corresponding size may be reduced by one if the object is deallocated, and the number of allocations may be increased by one if the object is allocated. This list may be used to record the number of active allocated objects having the corresponding size that currently exist on the GPU. In an example in the drawing, the list has a size of 10. In implementation, the list may use a different size.

The electronic apparatus may add a total number of allocations to an end of the list each time the object is allocated. If the list is full, the first element may be replaced. If the list is not filled with 10 elements, all the objects may be allocated to the memory.

If the list is full, ranges of the maximum and minimum values in the list may be measured and compared to a predetermined value to thus determine whether the object is to be allocated asynchronously (1330).

The shorter-lifespan object tends to be allocated and deallocated repeatedly within a short period of time. In this case, the range of the list may be maintained to be small because the active object shows a pattern of being continuously increased and decreased. For the longer-lifespan object, the number of active objects are increased and the range of the list are increased.

Based on this verification, the present disclosure shows that the object having the corresponding size may be asynchronously allocated if the range of the above-mentioned list is less than the specific X value. This heuristic manner may require no profiling stage and no changes to the code base of the homomorphic ciphertext library used in the present disclosure although this manner does not guarantee that all the short-lifespan objects are allocated asynchronously.

The description below describes an effect of the operation allocation method.

A plurality of graphics cards (NVIDIA A40, Geforce GTX 1660 Ti, and GeForce GTX 1050 GPUs) are used to verify the above effect. Here, each GPU performs a different task. All experiments are performed using CUDA 12, using a custom workload written in C++ that interacts with the homomorphic ciphertext library used in the present disclosure.

Each method modifies the library code, and a modification range may be different for each method. The dynamic method may be the least invasive because this method only changes the memory allocator, while the static method may be the most invasive because this method requires manually modifying the allocation method for the temporary object.

The profiling allocation scheme uses a file and a script to process the data and determines the optimal allocation method, which requires a series of manual steps.

The A40 GPU executes the BM-bootstrap (CKKS bootstrapping benchmark) and ResNet, which are large-scale tasks that respectively use the memories of about 80 GB and 200 GB. The A40 GPU tests only the profiling allocation scheme described in Section III-C, which shows the best performance among the three methods. The BM-bootstrap is a bootstrapping benchmark that performs different bootstrapping tasks sequentially.

After each task, the parameter and the required key are switched to a next task. ResNet is a pre-trained homomorphic ResNet-20 model that tests an inference operation in a homomorphic state.

Referring to FUG. 14, it may be seen that the performance of each bootstrapping task and the peak threshold value of the asynchronous memory (i.e., ratio of the allocated GPU object). It may be seen that setting the peak asynchronous memory threshold value to a medium level (about 40 to 60%) results in the fastest bootstrapping time in most of the bootstrapping tasks.

It may be seen that ResNet has the best performance if the peak asynchronous memory threshold value is set to 65%. A red line indicates the performance of a manual swap, where the programmer manually swaps the GPU object to the host memory.

The delay time of ResNet is about 1657 seconds, and reduced by about 22% to 1296 seconds in case of using the profiling allocation.

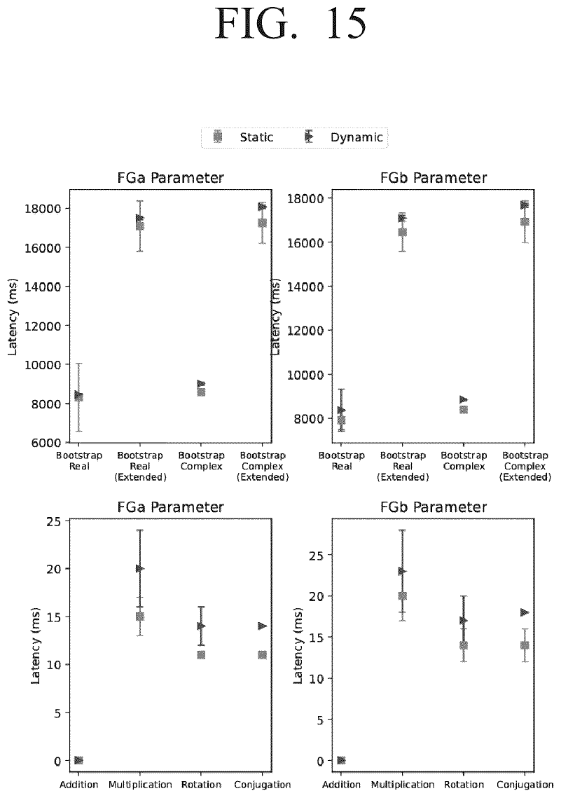

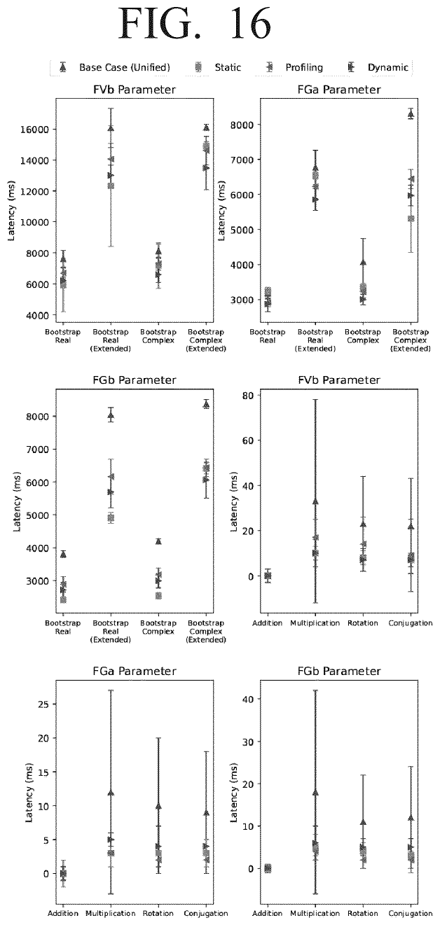

FIGS. 15 and 16 are diagrams showing performance of various homomorphic operations. In detail, FIGS. 15 and 16 show delay time results of several homomorphic encryption functions using various parameters FGa, FGb, and FVb on GeForce 1660 Ti and 1050 GPU cards.

Referring to FIGS. 15 and 16, it may be seen that the static method shows the best performance for a large parameter. On the other hand, it is difficult to clearly determine the optimal access method for a small parameter.

In addition, the dynamic method has a great advantage because this method does not require modifying an internal library source code. The profiling is performed and applied to the asynchronous allocation at a ratio of 68%.

Fully managed memory is the slowest in all the tests and the delay time fluctuates greatly. In particular, referring to FIG. 15, which shows a performance comparison in case of using a graphics card having a small 2 GB VRAM, it may be seen that the static method is slightly faster despite showing similar performance at the corresponding memory size. This phenomenon is possible because the method allows accurate determination of which object needs to be allocated asynchronously within a specific code.

As described above, in the present disclosure, three methods are designed that use a hybrid allocation strategy by coupling the first allocation function with the second allocation function to provide better performance than the unified memory method used alone in the task of processing the homomorphic ciphertext.

This method provides the static allocation method having a 31% improvement over the conventional method, and the profiling allocation scheme having a 22% performance improvement over the manual switching of the GPU object by an experienced programmer having deep understanding of the homomorphic ciphertext library code base used in the present disclosure.

Finally, it may be seen that the dynamic allocation method is implemented to show that this method provides up to 50% better performance compared to a case of the basic unified memory in the bootstrapping task.

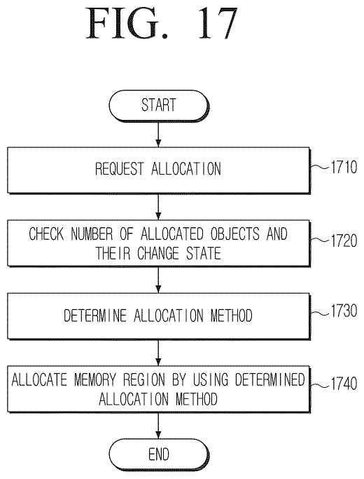

FIG. 17 is a flowchart showing a homomorphic processing method according to an embodiment of the present disclosure.

Referring to FIG. 17, the method may include checking a predetermined situation (1720) if a memory allocation request is input (1710) as at least one instruction is performed. For example, it may be checked whether usage of a graphics-processing unit (GPU) memory is a predetermined ratio or more and an operation object that requires a long operation time is in operation. Here, the operation object may use at least one of a bootstrapping operation or a fully homomorphic encryption (FHE) operation.

Meanwhile, in implementation, an operation type may be directly identified, and whether the operation object that requires a long operation time is in operation may also be checked based on a difference between the maximum and minimum values of a list within a predetermined time.

To this end, information on a list of blocks corresponding to a plurality of memory regions and indicating whether each block is in use may be managed by the electronic apparatus, and an active object in current use may be checked based on the list.

In addition, a method for allocating a memory may be determined based on the identified situation (1730). In addition, the method for allocating a memory may be applied based on the determined allocation method (1740). For example, a first allocation method for allocating the memory region in a stream order may be used to allocate the memory region required for each instruction while at least one instruction is performed if no predetermined situation occurs. For example, an object related to a homomorphic operation may be allocated to a second memory if usage of the GPU memory is less than a predetermined ratio.

On the other hand, a second allocation method for allocating the memory region by using a synchronization method may be used if the predetermined situation occurs. For example, a first memory using a dynamic random-access memory (DRAM) method and the second memory using a video random access memory (VRAM) method may be unified and managed, and the object related to the homomorphic operation may be allocated to at least one of the first memory or the second memory.

As described above, the control method according to the present disclosure may allocate the memory without any error such as a memory shortage while processing an operation on a homomorphic ciphertext. In addition, the memory allocation may be performed using an asynchronous method within an allowable limit, thus enabling the homomorphic operation to be performed faster.

Meanwhile, the methods according to at least some of the various embodiments of the present disclosure described above may be implemented in the form of an application capable of being installed on the conventional electronic apparatus.

In addition, the methods according to at least some of the various embodiments of the present disclosure described above may be implemented only by the software or hardware upgrade of the conventional electronic apparatus.

In addition, the methods according to at least some of the various embodiments of the present disclosure described above may be performed through an embedded server disposed in the electronic apparatus, or at least one external server of the electronic apparatus.

Meanwhile, according to an embodiment of the present disclosure, the various embodiments described above may be implemented by software including an instruction stored in a machine-readable storage medium (for example, a computer-readable storage medium). A machine may be an apparatus that invokes the stored instruction from the storage medium, may be operated based on the invoked instruction, and may include the electronic apparatus (e.g., electronic apparatus A) according to the disclosed embodiments. If the instruction is executed by the processor, the processor may directly perform a function corresponding to the instruction or another component may perform the function corresponding to the instruction under the control of the processor. The instruction may include codes generated or executed by a compiler or an interpreter. The machine-readable storage medium may be provided in the form of a non-transitory storage medium. Here, the “non-transitory storage medium” may refer to a tangible device and only indicate that this storage medium does not include a signal (e.g., electromagnetic wave), and this term does not distinguish a case where data is stored semi-permanently in the storage medium and a case where data is temporarily stored in the storage medium from each other. For example, the “non-transitory storage medium” may include a buffer in which data is temporarily stored. According to an embodiment, the methods according to the various embodiments disclosed in the present document may be included and provided in a computer program product. The computer program product may be traded as a product between a seller and a purchaser. The computer program product may be distributed in a form of the machine-readable storage medium (for example, a compact disc read only memory (CD-ROM)), or may be distributed online (e.g., downloaded or uploaded) through an application store (e.g., PlayStore™) or directly between two user devices (e.g., terminal devices). In case of the online distribution, at least a part of the computer program product (e.g., downloadable app) may be at least temporarily stored or temporarily provided in the machine-readable storage medium such as a server memory of a manufacturer, a server memory of an application store, or a relay server memory.

The various embodiments of the present disclosure may be implemented by the software including an instruction stored in a machine-readable storage medium (for example, a computer-readable storage medium). The machine may be an apparatus that invokes the stored instruction from the storage medium, may be operated based on the invoked instruction, and may include the electronic apparatus (e.g., electronic apparatus 100) according to the disclosed embodiments.

If the instruction is executed by the processor, the processor may directly perform the function corresponding to the instruction or another component may perform the function corresponding to the instruction under the control of the processor. The instruction may include the codes generated or executed by the compiler or the interpreter.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

1. An electronic apparatus comprising:
a memory; and
a processor configured to perform a homomorphic operation by performing at least one instruction,
wherein the processor is configured to
use a first allocation method for allocating a memory region in a stream order to allocate the memory region required for each instruction while performing the at least one instruction, and
use a second allocation method for allocating the memory region by using a synchronization method if a predetermined situation occurs.

2. The apparatus as claimed in claim 1, wherein the processor is configured to
use the second allocation method if usage of a graphics-processing unit (GPU) memory is a predetermined ratio or more and an operation object that requires a long operation time is in operation.

3. The apparatus as claimed in claim 2, wherein the operation object uses at least one of a bootstrapping operation or a fully homomorphic encryption (FHE) operation.

4. The apparatus as claimed in claim 2, wherein the processor is configured to check whether the operation object that requires a long operation time is in operation based on a difference between the maximum and minimum values of a list within a predetermined time.

5. The apparatus as claimed in claim 1, wherein the memory includes a first memory using a dynamic random-access memory (DRAM) method and a second memory using a video random access memory (VRAM) method, and
the processor is configured to
unify and manage the first memory and the second memory, and
allocate an object related to the homomorphic operation to at least one of the first memory or the second memory.

6. The apparatus as claimed in claim 5, wherein the processor is configured to allocate the object related to the homomorphic operation to the second memory if usage of a graphics-processing unit (GPU) memory is less than a predetermined ratio.

7. The apparatus as claimed in claim 5, wherein the processor is configured to
manage information on a list of blocks corresponding to the plurality of memory regions and indicating whether each block is in use, and
check an active object in current use based on the list.

8. A control method of an electronic apparatus, the method comprising:
checking a predetermined situation if a memory allocation request is input as at least one instruction is performed;
using a first allocation method for allocating a memory region in a stream order to allocate the memory region required for each instruction while the at least one instruction is performed if no predetermined situation occurs; and
using a second allocation method for allocating the memory region by using a synchronization method if the predetermined situation occurs.

9. The method as claimed in claim 8, wherein in the checking,
whether usage of a graphics-processing unit (GPU) memory is a predetermined ratio or more and an operation object that requires a long operation time is in operation are checked.

10. The method as claimed in claim 9, wherein the operation object uses at least one of a bootstrapping operation or a fully homomorphic encryption (FHE) operation.

11. The method as claimed in claim 9, wherein in the checking,
whether the operation object that requires a long operation time is in operation is checked based on a difference between the maximum and minimum values of a list within a predetermined time.

12. The method as claimed in claim 8, in which the electronic apparatus includes a first memory using a dynamic random-access memory (DRAM) method and a second memory using a video random access memory (VRAM) method,
wherein in the using of the second allocation method,
the first memory and the second memory are unified and managed, and
an object related to a homomorphic operation is allocated to at least one of the first memory or the second memory.

13. The method as claimed in claim 12, wherein in the using of the first allocation method,
the object related to the homomorphic operation is allocated to the second memory if usage of a graphics-processing unit (GPU) memory is less than a predetermined ratio.

14. The method as claimed in claim 12, wherein in the checking,
information on a list of blocks corresponding to the plurality of memory regions and indicating whether each block is in use is managed, and
an active object in current use is checked based on the list.

15. A non-transitory computer-readable recording medium storing a program for executing a control method of an electronic apparatus, wherein the method includes
checking a predetermined situation if a memory allocation request is input as at least one instruction is performed,
using a first allocation method for allocating a memory region in a stream order to allocate the memory region required for each instruction while the at least one instruction is performed if no predetermined situation occurs, and
using a second allocation method for allocating the memory region by using a synchronization method if the predetermined situation occurs.
